(19) United States
(12) Patent Application Publication
(10) Pub. No.: US 2016/0334764 A1
(43) Pub. Date: Nov. 17, 2016

(54) METHOD AND APPARATUS FOR REMOTE OPERATION OF AN INDUSTRIAL CONTROLLER

(71) Applicant: Beyond HMI, Inc., Katy, TX (US)

(72) Inventor: Drew Taylor Mills, Katy, TX (US)

(21) Appl. No.: 14/713,904

(22) Filed: May 15, 2015

(51) Int. Cl. G05B 15/02

(52) U.S. Cl. CPC G05B 15/02

(57) ABSTRACT

A remote operator interface (ROI) module is disclosed that provides remote access and control of a piece of industrial equipment. The ROI module includes a communications port for receiving wireless control commands from a computing device. A microprocessor or microcontroller process the control commands for communication to the piece of industrial equipment. In some embodiments, a computer program product is provided that provides an interface displayed on the computing device. Aspects of the computer program product may also be resident on the microprocessor or microcontroller for processing commands for compatibility with different types of industrial equipment.

### CROSS-REFERENCE TO RELATED APPLICATIONS

None.

### BACKGROUND

The embodiments herein relate generally to industrial controls and more particularly, to remote operation of an industrial controller.

Industrial controllers are utilized for controlling industrial processes and equipment. Historically, human operators have interacted with these controllers using either pilot devices (indicator lights, switches and potentiometers) or Electronic Operator Interfaces (such as keypads, displays, and touchscreen displays.

The current methods require a human operator to reside in close proximity to the industrial process in order to operate the equipment. This causes the human operator to be less productive and can compromise his physical safety.

Additionally EOIs installed in outdoor applications can be impacted by environmental conditions. Sunlight and extreme temperatures can render these devices unusable and might permanently damage the device.

Industrial equipment manufacturers each provide distinct human interface features with their products. A single human operator might need to learn dozens of different operator interfaces in order to complete his daily tasks. These human interface devices are expensive and they perform poorly in extreme environmental conditions (heat, cold, bright sunlight).

Referring to FIG. 1, the traditional methods for a human operator to control a PLC or RTU 101 are illustrated. In some cases a combination keypad/display device 105 exchanges data values and commands through one or more of the PLC/RTU communication ports 102. In other circumstances, the operator controls the machine using switches 108 connected to PLC/RTU discrete input terminals 104 and/or potentiometers 107 connected to PLC/RTU analog input terminals 103. Additionally, the PLC or RTU 101 could be controlled using a combination of keypad display 105, potentiometers 107, and switches 108. A modern touchscreen display 106 can also be used to interact with the PLC or RTU 101 through communication ports 102. These devices provide all the functionality of a keypad/display 105 but also provide “mimics” to simulate interactions with physical switches 108 and physical potentiometers 107.

In some cases, the keypad display 105, touchscreen display 106, potentiometers 107, and switches 108 are permanently installed on a panel which is part of or is attached to the PLC or RTU 101 enclosure. In other cases, the keypad display 105, touchscreen display 106, potentiometers 107, and/or switches 108 can reside on separate panel. Electrical connections between the keypad display 105, touchscreen display 106, potentiometers 107, and switches 108 are facilitated using wiring connected to the PLC/RTU 101.

As can be seen, there is a need for a common, universal operator interface device which permits a human operator to monitor and adjust a variety of industrial equipment via a single device and interface which can be operated remotely from the industrial equipment.

### SUMMARY

In one aspect, a remote operator interface (ROI) module for industrial control equipment comprises a radio communications module for receiving wireless control commands from a computing device. A microcontroller or microprocessor may be coupled to the radio communications module to process the control commands. A first memory module coupled to the microprocessor or microcontroller. The first memory module may include executable instructions to operate a piece of industrial equipment according to the control commands. A second memory module coupled to the microprocessor or microcontroller. The second memory module may store and retrieve human interface screen definition information for use by the computing device. A communication port may be configured to connect to and communicate the control commands from the microcontroller or microprocessor to an industrial machine controller in the piece of industrial equipment.

In another aspect, a computer program product for remote control of industrial equipment comprises a non-transitory computer readable storage medium having computer readable program code embodied therewith, the computer readable program code being configured to: initiate a wireless connection from a computing device to a module coupled to a piece of industrial equipment, the module including memory storage including human interface screen definitions and credentials for access to the piece if industrial equipment; provide a control interface for the piece of industrial equipment on a display of the computing device; transmit a control command wirelessly from the computing device to the module; and transmit the control command from the module to an industrial machine controller in the piece of industrial equipment.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram showing the communication in a conventional operator interface for industrial equipment.

FIG. 2 is a block diagram of a system for remote control of an industrial piece of equipment in accordance with an exemplary embodiment of the subject technology.

FIG. 3 is a block diagram of a remote operator interface module of FIG. 2 in accordance with an exemplary embodiment of the subject technology.

FIG. 4 is a block diagram of a system for loading user-authentication information, PLC/RTU interface information, and display screen definitions into a remote operator interface module in accordance with an exemplary embodiment of the subject technology.

FIG. 5 is a flowchart of a method of interaction between a computing device and a remote operator interface in accordance with an exemplary embodiment of the subject technology.

FIG. 6 is an example of a screen image which might be rendered on a user interface display of a portable device in accordance with an exemplary embodiment of the subject technology.

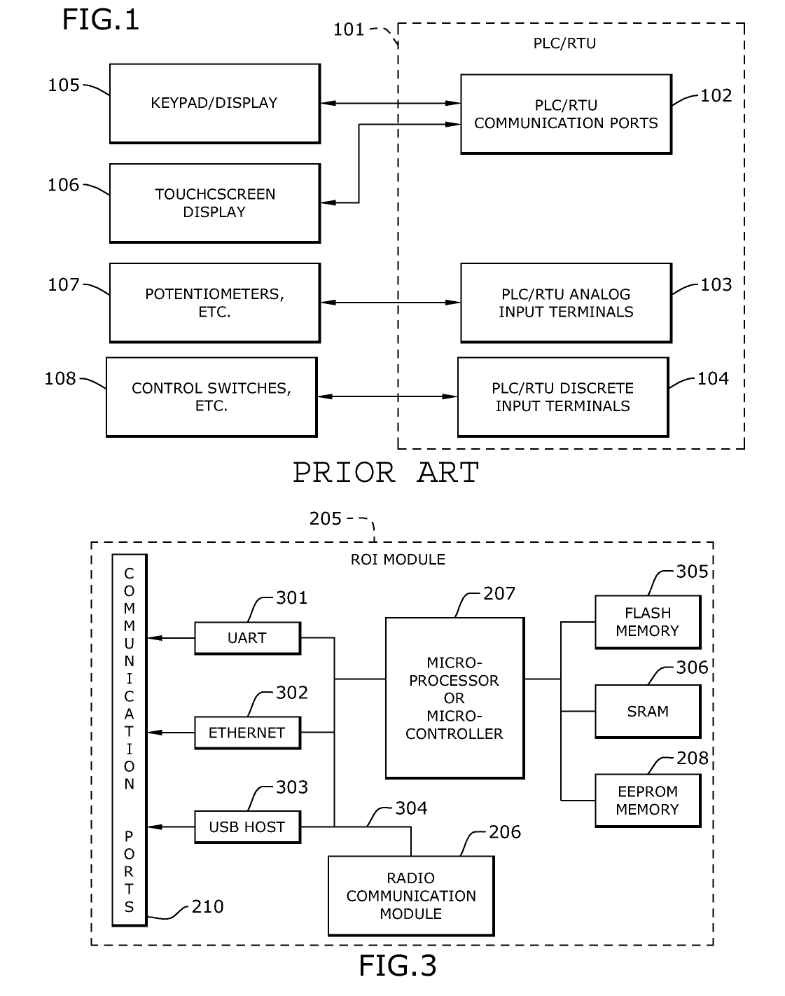

### DETAILED DESCRIPTION OF CERTAIN EMBODIMENTS

In general, embodiments of the present disclosure provide control of industrial equipment remotely via a general computing device, for example a portable computing device (for example, a smartphone, tablet, PDA, laptop, or wearable device) to communicate with all devices that control a process. The operator can operate the equipment remotely, so he or she can stay safe and comfortable (for example, from within the cab of a vehicle rather than out in the weather and hazards in proximity to equipment). A small electronic device receiving radio signals may reside within an industrial control panel. This electronic device communicates with the industrial controller and using a radio transceiver communicates with a remote operator interface (ROI) using software executing process steps on a portable general computing device. A human operator can interact with the portable device to monitor and/or control one or more industrial devices remotely thus allowing the operator to remain a safe distance from the industrial process. The same portable device can be used to operate a variety of different industrial controllers thereby reducing the need for operator training Further advantages include the elimination of costly and delicate touchscreen, keypad, and display components from the industrial panel. This significantly reduces the initial cost and long term maintenance cost of the industrial controller interface. Aspects of the subject technology reduce cost while increasing operator safety and productivity.

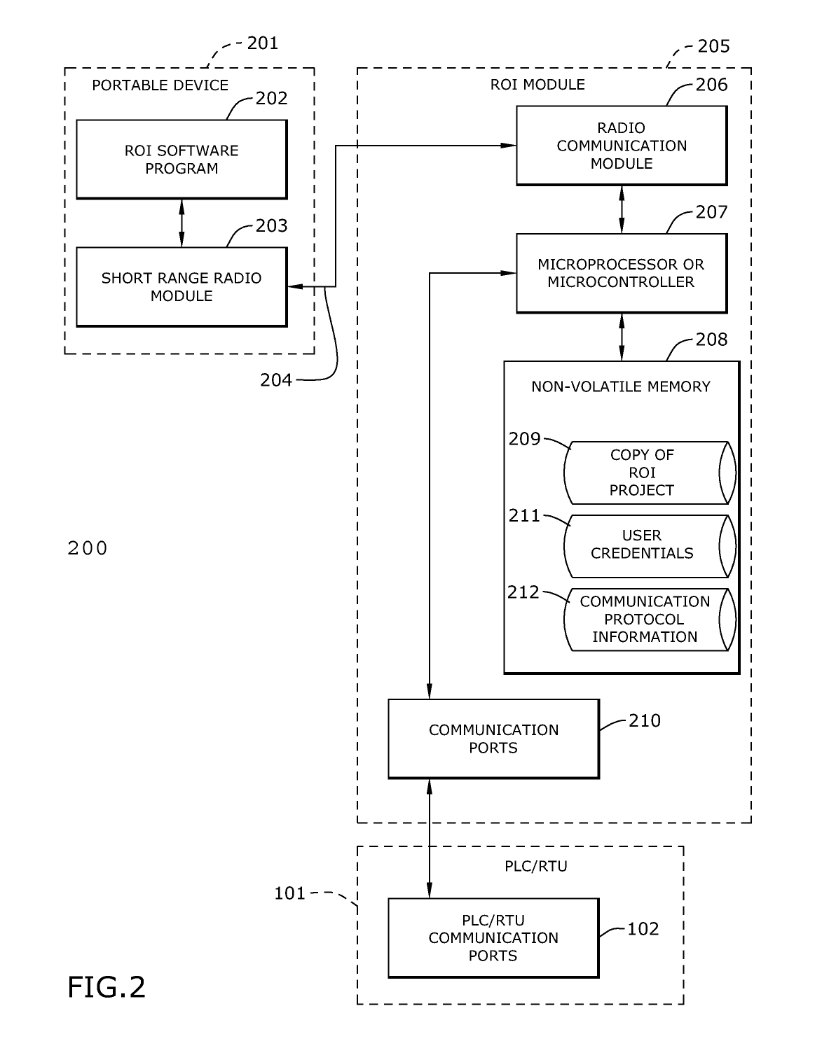

Referring now to FIG. 2, an exemplary embodiment of a remote operator interface (ROI) system 200 is illustrated. A portable device 201 such as a smartphone, tablet, personal data assistant (PDA), wearable device or laptop computer executes a remote operator interface software program 202. The software program 202 interacts with the portable device's 201 short range radio module 203 to communicate with a dedicated remote operator interface module 205 via radio signals 204. In at least one embodiment, the radio signals 204 could follow the Bluetooth or Bluetooth Low Energy (BLE) radio transmission standard.

The Remote Operator Interface Module (ROI Module) 205 includes a microprocessor or microcontroller 207 and non-volatile memory 208 which could be but does not have to be of the electrically erasable programmable read only memory (EEPROM) type. Within this non-volatile memory 208 resides a copy of an ROI project file 209, information about user credentials 211, and attributes necessary to conduct communications with the PLC/RTU 212. The ROI module 205 further consists of a plurality of communications ports 210 which can be used by the microprocessor/microcontroller 207 to exchange data with communications ports 102 of the PLC/RTU 101. In an exemplary embodiment, the communications ports 210 may be hardwired to the communications ports 102.

Referring to FIG. 3, a general component block diagram of an example remote operator interface (ROI) module 205 is shown in accordance with an embodiment of the subject invention. A plurality of devices may be disposed on a peripheral bus 304: for example, one or more universal asynchronous receiver-transmitters (UARTs) 301, one or more Ethernet ports 302, and one or more universal serial bus (USB) host interfaces 303 to support communication with industrial equipment controllers via communications ports 210. In one embodiment, only a USB port 303 and a UART port 301 are utilized.

The remote operator interface module 205 further comprises a microprocessor or microcontroller 207, which executes instructions stored in flash memory 305. The microprocessor or microcontroller 207, stores data in SRAM 306 during normal operation. Non-volatile (EEPROM) memory 208 supplies non-volatile memory storage for data including user-credentials 211, PLC/RTU interface information 212, and display screen definitions 209.

A radio communication module 206 supports wireless communications between the remote operator interface module 205 and the external portable device (smartphone, tablet, personal data assistant, or computer) 201. In at least one embodiment, the radio communications module 206 utilizes either the Bluetooth or Bluetooth Low Energy (BLE) technology standard.

It is to be appreciated that this is only a single example, and a plurality of configurations are possible within the scope and spirit of the subject invention.

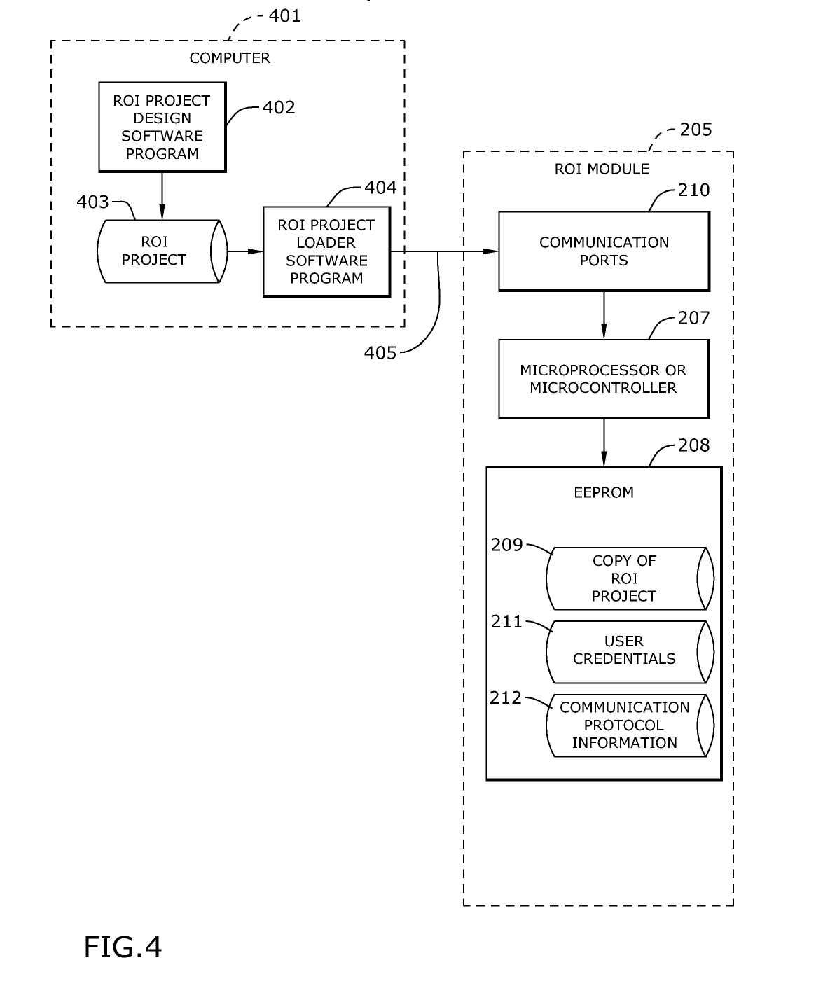

Referring to FIG. 4, an example system for loading user credentials 211, PLC/RTU interface information 212, and display screen definitions 209 into a remote operator interface module 205 is illustrated. A general computing device 401 (for example, the general computing device 201 of FIG. 2) may include at least one program product 402 having a set (e.g., at least one) of program modules that are configured to carry out the functions of embodiments of the subject technology. The program product/utility 402, having a set (at least one) of program modules, may be stored for example in the flash memory 305 (FIG. 3) by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of embodiments of the subject technology as described herein. For example, the program product 402 may be in the form of a project design software program which defines the various aspects of a ROI project file 403. In at least one embodiment, the file 403 contains definitions of the individual display screens which will be presented to the user via the portable device 201 (FIG. 2).

An ROI project loader software program 404 may also be executed on the general computing device 401 to perform the following tasks:

Transfer the project file 403 from the general computing device 401 to the ROI module 205;

Designate and transfer user credential information 211 to the ROI module 205;

Designate and transfer attributes 212 necessary to conduct communications with the PLC/RTU 101.

The designated transfer of information may be conducted via communications media 405 consisting of either UART 301, Ethernet 302, USB 303, or radio 206, or similar media. The microprocessor or microcontroller 207 of the ROI module 205 receives the information about the ROI project file 403, the user credential information 211, and PLC/RTU communications parameters 212 via the ROI module's 205 communication ports 210 and places the information 209, 211, 212 in for example non-volatile (EEPROM) memory 208.

In at least one embodiment, the features of the ROI project loader software program 404 are included in the ROI project design software program 402. In at least one embodiment, the ROI project loader software program 404 and the ROI project design software program 402 are separate software programs.

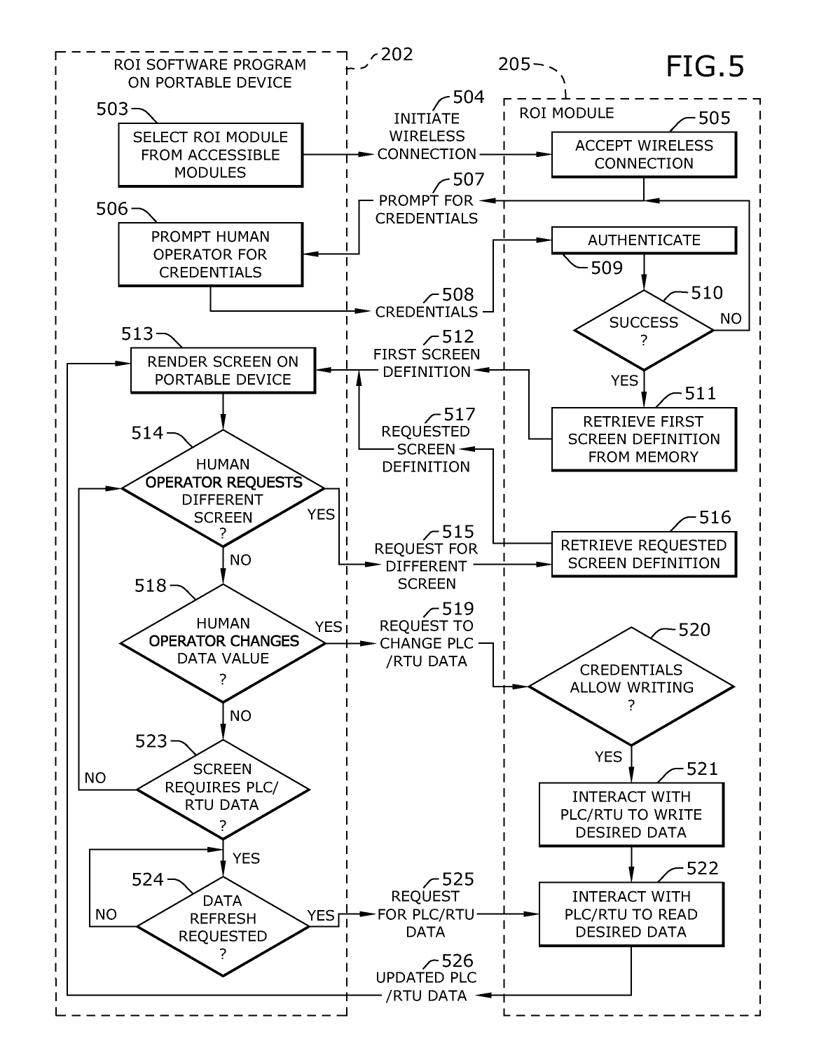

Referring to FIG. 5, a process of interaction between the ROI program 202 on the portable device 201 (FIG. 2) and the ROI module 205 is shown. In this example, the portable device software program 202 presents the human user with a list of ROI modules 205 and associated industrial equipment which are in communication range. The human operator then selects the ROI module with which he wishes to connect 503. The ROI software program 202 then initiates 504 a radio connection. The ROI module 205 receives the initiation request 504 and establishes 505 the radio data transfer connection through which data will be interchanged between the ROI software program 202 and the ROI module 205.

After establishing 505 a data transfer connection the ROI module 205 prompts 507 for user credentials. The ROI program 202 receives this prompt and provides 506 a perceivable prompt to the human user. The prompt could be visual, audio, vibration, or another type of sensory prompt. After the human operator has provided 508 his credentials, the ROI software program 202 passes the credentials to the ROI module 205 via the radio data link 204 (FIG. 2). Upon receiving the credentials, the ROI module 205 authenticates 509 the credentials using data stored within its non-volatile memory 208 (FIG. 2). If authentication fails 510, the ROI module 205 may take one of many actions. In at least one embodiment, the ROI module 205 repeats the prompt 207 for credentials. If authentication succeeds, the ROI module 205 retrieves 511 the definition of the first screen from the ROI project file 209 (FIG. 2) stored within its non-volatile memory 208 (FIG. 2) and transmits 512 that data to the ROI software program 202 via the radio data link 204 (FIG. 2).

It should be noted that user authentication is not a requirement of this invention. In at least one embodiment, the steps in the user authentication process (steps 506, 507, 508, 509, 510) can be bypassed and the ROI module 205 could immediately transmit 512 the first screen upon acceptance of the wireless connection 505.

In at least one embodiment, the authentication 509 process can differentiate between human operators with different credentials to permit “read/write” permissions to some users while prohibiting “write” permissions for other users.

After the ROI software program 202 receives the screen definition, the ROI software program 202 renders 513 the specified images on the display of the portable device 201 (FIG. 2). The rendered screen can contain, but is not limited to images which fall into one or more of the following categories:

Images which appear differently—depending upon the value of certain data elements in the PLC/RTU 101. These could include, but are not limited to:

“read only” text boxes

“read only” Mimics of switches

“read only” Mimics of lights

“read only” Static text

Charts, graphs, etc.

Mimics of physical objects such as tanks, vessels, pumps, fans, etc.

Images which appear differently—based on values of data elements in the PLC/RTU 101 and can also be manipulated (via touch or voice commands, for instance) to change values of the associated data elements within the PLC/RTU 101. These could include, but are not limited to:

“read/write” text boxes

“read/write” Mimics of switches

Images which can be manipulated (via touch or by voice commands, for instance) to cause the presentation of a different ROI screen.

After a screen has been rendered 513 on the portable device 201 (FIG. 2), the portable device 201 (FIG. 2) may await an “event”. One type of event occurs when a human operator manipulates an image on the screen of the portable device 201 (FIG. 2) in an attempt to request 514 a different screen. The event causes the ROI program 202 to transmit 515 a request for a new screen to the ROI module 205 via the radio data link 204 (FIG. 2). Upon receiving the screen request, the ROI module 205 retrieves 516 the requested screen from the ROI project file 209 (FIG. 2) stored within its non-volatile memory 208 (FIG. 2) and transmits 517 the new screen definition information to the ROI software program 202 on the portable device 201 (FIG. 2) via the radio data link 204 (FIG. 2). The event is completed when the ROI software program 202 renders 513 the specified images on the display of the portable device 201 (FIG. 2).

Another type of event which may occur in the ROI software program 202 when the human user manipulates an image on the display of the portable device 201 in such a way as to request 518 the changing of a data value. When this type of event occurs, the ROI program 202 transmits 519 the requested change to the ROI module 205 via the radio data link 204. Upon receiving a request 519 to change data value, the ROI module 205 refers to the permissions assigned to the authenticated user to determine 520 whether to execute the request. If the authenticated user is permitted to change data values, the ROI module 205 interacts 521 with the RTU/PLC 101 via communication ports 210 and requests the specified change. If the authenticated user does not have permission to change data in the PLC/RTU 101, the ROI module 205 can respond in different ways. In at least one embodiment, the ROI module 205 simply ignores the request. In at least one embodiment, after interacting 521 to request a change to an RTU/PLC 101 data value, the ROI module 205 will interact with the RTU to read back 522 the value of the data element which was just requested for change. The most recent value of this PLC/RTU data element is then returned 526 to the ROI software program 202 via the radio data link 204 (FIG. 2) and the ROI software program 202 again renders 513 the screen on the portable device 201.

Still another type of event may occur in the ROI software program 202 when a refresh of PLC/RTU 101 data is requested 524. If a screen which has been rendered on the portable device 201 (FIG. 2) contains images which depend on PLC/RTU 101 data, then—in at least one embodiment—the ROI program can request 525 a data value refresh immediately after the screen definition has been received 517. In another embodiment, the ROI program 202 requests 525 a data value refresh after the screen has been rendered 513. Data refresh requests can also be triggered when a human operator manipulates the ROI software program 202 (by touch or by voice command, etc.) or by a timer in the ROI software program 202 which attempts to refresh data at some pre-determined frequency. When the ROI software program 202 requests 525 a data refresh via the radio data link 204 (FIG. 2), the ROI module 205 may read 522 the requested data elements from the PLC/RTU 101. The resulting values may be returned 526 to the ROI software program 202 via the radio data link 204 (FIG. 2) and the ROI software program 202 may again render 513 the screen on the portable device 201 (FIG. 2).

In another embodiment, the ROI module 205 determines when to refresh data by reading 522 the required data elements 522 from the PLC/RTU 101 (FIG. 2). In this embodiment, the ROI module 205 determines which data elements to read from the PLC/RTU 101 based on its knowledge of the last screen definition transmitted to the ROI program 202.

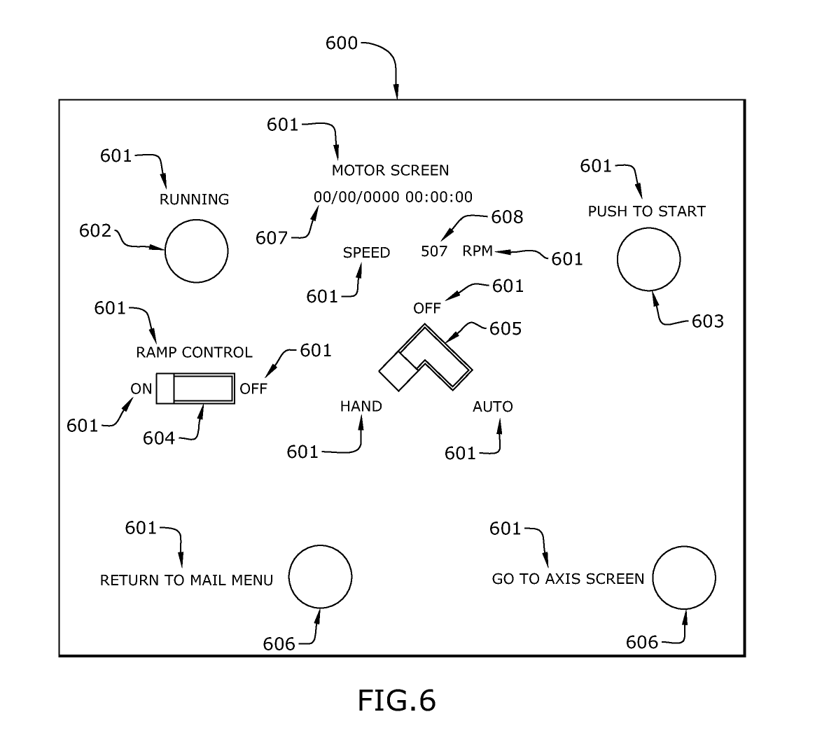

Referring to FIG. 6, an example screen 600 for a remote operator interface is illustrated. The screen 600 is rendered on the display of the portable device 201 based upon screen definition information supplied by the ROI module 205. This example screen 600 depicts multiple instances of static text (label) images 601. An example of an indicator light mimic 602 is also depicted. The indicator light mimic 602 may be configured so that its color changes depending upon the value of one or more data elements in the PLC/RTU 101 (FIG. 2). A push-button mimic 603 is also illustrated. The human operator may commonly interact with a push-button mimic 603 by touching the screen to simulate the action of a “momentary contact” switch. By pressing on the push-button mimic 603, the human operator triggers a request to change the value of data in the PLC/RTU 101 (FIG. 2). A two-state toggle switch mimic 604 may allow the human operator to drag or click to simulate the action of a double-throw switch. When the pole image of the switch mimic 604 shifts from one end of the image to the other, the human operator is requesting that the value of a PLC/RTU 101 (FIG. 2) data element be changed between two pre-configured values. The three-state toggle switch mimic 605 works like a two-state toggle switch but permits the human operator to switch a PLC/RTU 101 (FIG. 2) data element between three pre-configured values. Screen change buttons 606 may be used by the human operator to request that a different screen be rendered on the portable device 201 (FIG. 2) display. The clock-calendar mimic 607 displays the value of the PLC/RTU 101 (FIG. 2) system clock. A text box 608 may display the value of data elements from the PLC/RTU 101 (FIG. 2). While only one text box 608 is shown, it will be understood that a plurality of text boxes 608 may be used within the scope of the subject technology. The text box 608 may be of the “read only” type in which case the value read from the PLC/RTU 101 (FIG. 2) is displayed in numerical digits without any ability to modify the data. The text box 608 may also be of the “read/write” type, in which case, the value from the PLC/RTU 101 (FIG. 2) is displayed. Additionally the human user can interact with the value to initiate a request for change of data value. In at least one embodiment, the human operator can tap or click on the text box 608 and a numerical keypad is displayed by the operator interface whereby the human user can enter a new value for the data element and either request the change or cancel the change operation.

The examples illustrated in FIG. 6 are representative of some of the image types which might be available for implementation in the ROI project designer software program 402. This example should not be interpreted as a complete description of available images and mimics. For example, a “tabular” image—depicting rows and columns of data—might also be available. Furthermore, X-Y coordinate or “polar” coordinate plots, bar charts, pie graphs or other similar graphical presentations might also be included in one or more ROI screens.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as “an aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such “an embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such “a configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A remote operator interface (ROI) module for industrial control equipment, comprising:
a radio communications module configured to receive wireless control commands from a computing device;
a microcontroller or microprocessor coupled to the radio communications module configured to process the control commands;
a first memory module coupled to the microprocessor or microcontroller, the first memory module including executable instructions to operate a piece of industrial equipment according to the control commands;
a second memory module coupled to the microprocessor or microcontroller, the second memory module used to store and retrieve human interface screen definition information for use by the computing device; and
a communication port configured to connect to and communicate the control commands from the microcontroller or microprocessor to an industrial machine controller in the piece of industrial equipment.

2. The ROI module of claim 1, wherein the computing device is a portable computing device.

3. The ROI module of claim 1, wherein the communication port is hardwired to the piece of industrial equipment.

4. A computer program product for remote control of industrial equipment, the computer program product comprising a non-transitory computer readable storage medium having computer readable program code embodied therewith, the computer readable program code being configured to:
initiate a wireless connection from a computing device to a module coupled to a piece of industrial equipment, the module including memory storage including human interface screen definitions and credentials for access to the piece if industrial equipment;
provide a control interface for the piece of industrial equipment on a display of the computing device;
transmit a control command wirelessly from the computing device to the module; and
transmit the control command from the module to an industrial machine controller in the piece of industrial equipment.

5. The computer program product of claim 4, wherein the step of transmitting the control command from the module to the industrial machine controller in the piece of industrial equipment is transmitted via a hardwired connection.

6. The computer program product of claim 4, further comprising presenting on the display a list of modules and a list of pieces of industrial equipment associated with each module.

7. The computer program product of claim 4, further comprising providing a prompt for credentials on the display.

8. The computer program product of claim 7, further comprising authenticating credentials input to the interface.

9. The computer program product of claim 4, wherein the control command changes a data value in the piece of industrial equipment.

10. The computer program product of claim 9, further comprising rendering the data value change on the display via a wireless signal to the computing device.
